(19) United States
(12) Patent Application Publication
(10) Pub. No.: US 2025/0355691 A1
(43) Pub. Date: Nov. 20, 2025

(54) METHOD FOR DATA STORAGE AND COMPUTING DEVICE

(71) Applicants: Huawei Technologies Canada Co., Ltd., Kanata (CA); The Governing Council of the University of Toronto, Toronto (CA)

(72) Inventors: Xiaomeng Tong, Shenzhen (CN); David Juen- Fung Lie, Toronto (CA); Yuqin Yan, Toronto (CA); Shengjie Xu, Toronto (CA); Wei Huang, Toronto (CA)

(21) Appl. No.: 18/664,104

(22) Filed: May 14, 2024

(51) Int. Cl. G06F 9/455

(52) U.S. Cl. CPC G06F 9/45558; G06F 2009/45583; G06F 2009/45595

(57) ABSTRACT

A method for data storage is applied to a cloud system that includes a plurality of virtual machines (VMs) and a control device. The method is performed by the control device. The method includes: receiving at least two requests from at least two VMs among the plurality of VMs, a request from each VM of the at least two VMs being used to indicate protected information of the VM; and mapping protected information of the at least two VMs to a first area of a cache. This can increase the difficulty for an attacker to carry out a side-channel attack, enhance the protection of information of each VM, and in turn avoid side-channel attacks.

### TECHNICAL FIELD

The present disclosure relates to the field of cloud computing technologies, and in particular, to a method for data storage and a computing device.

### BACKGROUND

A side-channel attack is a security vulnerability that exploits the leakage of side-channel information, such as time consumption, power consumption or electromagnetic radiation, during the execution of a system to attack the system. Side-channel attacks may have low cost and high efficiency and may pose a serious threat to the security of the system. Therefore, the information security issue of how to avoid side-channel attack has received widespread attention.

### SUMMARY

In an aspect, a method for data storage is provided. The method is applied to a cloud system, the cloud system includes a plurality of virtual machines (VMs) and a control device, and the method is performed by the control device. The method includes: receiving at least two requests from at least two VMs among the plurality of VMs, wherein a request from each VM of the at least two VMs is used to indicate protected information of the VM; and mapping protected information of the at least two VMs to a first area of a cache. In this way, the protected information of all the VMs can be mapped to the same cache area, so that the protected information of the VMs overlaps. This can increase the difficulty for an attacker to carry out a side-channel attack, enhance the protection of information of each VM, and in turn avoid side-channel attacks.

In a possible implementation manner, mapping the protected information of the at least two VMs to the first area of the cache, includes: adjusting storage areas in a main memory for the protected information of the at least two VMs.

In a possible implementation, the plurality of VMs include a first VM and a second VM; protected information of the first VM is stored in a first storage area in the main memory; protected information of the second VM is stored in a second storage area in the main memory, and the first storage area and the second storage area are mapped to different areas in the cache; and adjusting the storage areas in the main memory for the protected information of the at least two VMs, includes: storing the protected information of the first VM from the first storage area in the main memory into a third storage area in the main memory, the third storage area and the second storage area being mapped to the first area of the cache.

In a possible implementation manner, the plurality of VMs include a first VM and a second VM; protected information of the first VM is stored in a first storage area in the main memory; protected information of the second VM is stored in a second storage area in the main memory, and the first storage area and the second storage area are mapped to different areas in the cache; and adjusting the storage areas in the main memory for the protected information of the at least two VMs, includes: storing the protected information of the first VM from the first storage area in the main memory into a third storage area in the main memory; and storing the protected information of the second VM from a second storage area in the main memory into a fourth storage area in the main memory. The third storage area and the fourth storage area are mapped to the first area of the cache.

In a possible implementation manner, mapping the protected information of the at least two VMs to the first area of the cache, includes: mapping the protected information of the at least two VMs to the same cache line in the first area of the cache.

In a possible implementation manner, the request of each VM of the at least two VMs includes an identifier of a computational library that the VM uses.

In a possible implementation manner, the identifier of the encryption library included in the request of each VM is the same.

In a possible implementation manner, the request of each VM of the at least two VMs includes storage information of the VM.

In a possible implementation manner, the request of each VM of the at least two VMs is used to indicate critical information that the VM uses, and the critical information includes at least one of an encryption algorithm, an encryption library, packet metadata, an interpreted code, or persistently stored identity secrets.

In a possible implementation manner, the cache is a cache in a processor other than a processor where the plurality of VMs are deployed in the cloud system.

In a possible implementation manner, the cache is a cache in a processor where any of the plurality of VMs is deployed in the cloud system.

In a possible implementation manner, receiving the at least two requests from the at least two VMs among the plurality of VMs, includes: receiving the at least two requests from the at least two VMs within a period.

In a possible implementation manner, receiving the at least two requests from the at least two VMs among the plurality of VMs, includes: receiving the at least two requests from the at least two VMs at the same time.

In a possible implementation manner, the cloud system further includes a detection device; and the method further includes: controlling the detection device to detect whether an attack exists in the cloud system; and receiving alert information sent by the detection device when the detection device detects the attack.

In a second aspect, a computing device is provided. The computing device includes a memory and at least one processor coupled to the memory. The memory is configured to store computer instructions that, when executed by the at least one processor, cause the at least one processor to perform one or more steps of any method described herein.

In a third aspect, a non-transitory computer-readable storage medium is provided. The non-transitory computer-readable storage medium has stored thereon computer instructions that, when executed by a computer, cause the computer to perform one or more steps of any method described herein.

In a fourth aspect, a computer program product is provided. The computer program product includes computer instructions carried on a non-transitory computer-readable storage medium. The computer instructions, when executed by a computer, cause the computer to perform one or more steps of any method described herein.

### BRIEF DESCRIPTION OF THE DRAWINGS

FIG. 1A is a schematic diagram showing a structure of a cache, in accordance with some embodiments of the present disclosure;

FIG. 1B is a schematic diagram showing a scenario of a side channel attack, in accordance with some embodiments of the present disclosure;

FIG. 1C is a schematic diagram showing a scenario of a side channel attack mitigation, in accordance with some embodiments of the present disclosure;

FIG. 2A is a schematic diagram showing an architecture of a computer network system, in accordance with some embodiments of the present disclosure;

FIG. 2B is a schematic diagram showing a structure of a computer network system, in accordance with some embodiments of the present disclosure;

FIG. 3 is a schematic diagram showing a structure of a computing device, in accordance with some embodiments of the present disclosure;

FIG. 4 is a schematic diagram showing a flow of a method for data storage, in accordance with some embodiments of the present disclosure;

FIG. 5A is a schematic diagram showing a step of a method for data storage, in accordance with some embodiments of the present disclosure;

FIG. 5B is a schematic diagram showing a step of a method for data storage, in accordance with some other embodiments of the present disclosure;

FIG. 5C is a schematic diagram showing a step of a method for data storage, in accordance with yet some other embodiments of the present disclosure;

FIG. 6A is a schematic diagram showing another step of a method for data storage, in accordance with some embodiments of the present disclosure;

FIG. 6B is a schematic diagram showing another step of a method for data storage, in accordance with some other embodiments of the present disclosure;

FIG. 7A is a schematic diagram showing yet another step of a method for data storage, in accordance with some embodiments of the present disclosure; and

FIG. 7B is a schematic diagram showing yet another step of a method for data storage, in accordance with some other embodiments of the present disclosure.

### DETAILED DESCRIPTION OF ILLUSTRATIVE EMBODIMENTS

Technical solutions in some embodiments of the present disclosure will be described clearly and completely below with reference to the accompanying drawings. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the specification and the claims, the term “comprise” and other forms thereof such as the third-person singular form “comprises/includes” and the present participle form “comprising/including” are interpreted as open and inclusive meaning, i.e., “including, but not limited to”. In the description of the specification, the term such as “an embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representation of the above term does not necessarily refer to the same embodiment(s) or example(s). In addition, the specific features, structures, materials or characteristics may be included in any one or more embodiments or examples in any suitable manner.

In the description of some embodiments, the term “coupled” and its derivatives may be used. For example, the term “coupled” may be used when describing some embodiments to indicate that two or more components are in direct physical contact or electrical contact with each other. However, the term “coupled” or “communicatively coupled” may also mean that two or more components are not in direct contact with each other but still cooperate or interact with each other. The embodiments disclosed herein are not necessarily limited to the content herein.

The term “and/or” merely describes an association of associated objects, which include three situations. For example, “A and/or B” refers to three situations: A alone, A and B, and B alone.

Hereinafter, the terms “first” and “second” are only used for descriptive purposes and cannot be construed as indicating or implying the relative importance or implicitly indicating the number of indicated technical features. Thus, a feature defined with “first” or “second” may explicitly or implicitly include one or more features.

In the description of the embodiments of the present disclosure, the term “multiple”, “a plurality of” or “the plurality of” means two or more unless otherwise specified, and “multiple”, “a plurality of” or “the plurality of” may also be described as “at least two”.

As used herein, the term “if” is, optionally, construed as “when”, “in a case where”, “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of the phrase “applicable to” or “configured to” herein means an open and inclusive language, which does not exclude devices that are applicable to or configured to perform additional tasks or steps.

In addition, the phrase “based on” used herein has an open and inclusive meaning, since a process, step, calculation or other action that is “based on” one or more of the stated conditions or values may, in practice, be based on additional conditions or values exceeding those stated.

Hereinafter, in order to facilitate understanding of the solutions provided in the embodiments of the present disclosure, some terms involved in the embodiments of the present disclosure are explained before introducing the embodiments of the present disclosure.
1. Virtual machine (VM). VM refers to a complete computer system with complete hardware system functions simulated by software and running in a completely isolated environment. Operations that can be done on a physical computer can be done on a VM. Multiple VMs can be virtualized on one physical machine based on the virtualization technology, and each VM can run an operating system (OS).
2. Virtual machine monitor (VMM). VMM is a VM management platform, e.g., a hypervisor. The VMM is used to coordinate multiple VMs and allocate hardware resources (such as central processing unit (CPU), memory, disk, etc.) to the VMs. The hypervisor allows multiple VMs to share one or more CPUs. For example, the VMs managed by the VMM herein are also referred to as client VMs.
3. Cache. Cache refers to a storage device that can perform high-speed data exchange. Since the access speed of the cache is greater than the access speed of the main memory, the processor accesses the cache faster than it accesses the main memory, which can reduce CPU waiting time for data and accelerate CPU processing speed of data.

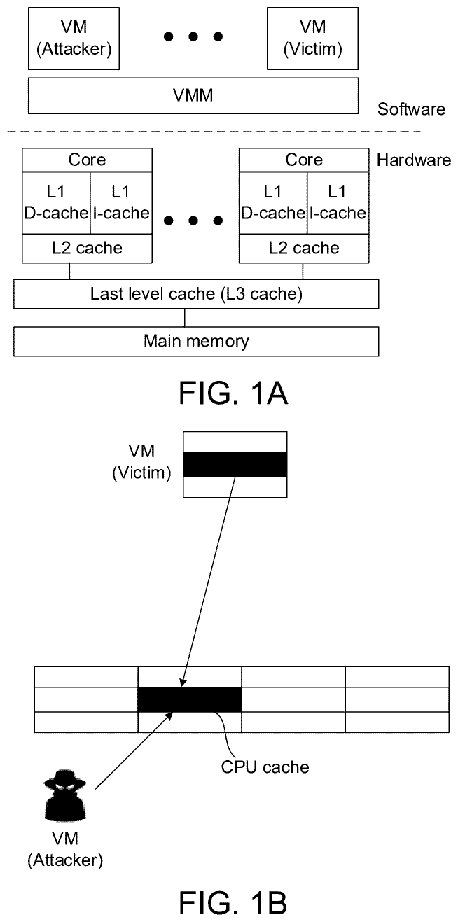

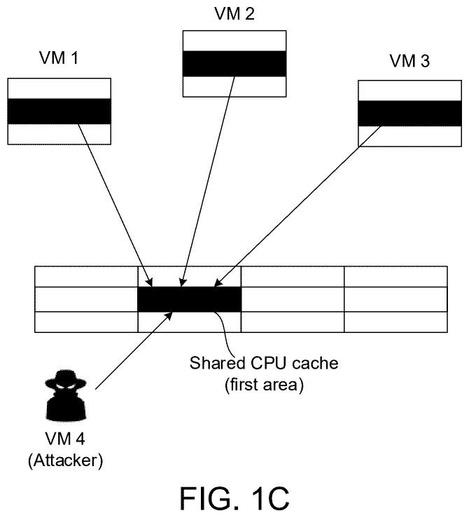

For example, referring to FIG. 1A which shows a multi-level cache, the multi-level cache can be divided into three levels, which are a first-level cache (L1 cache), a second-level cache (L2 cache) and a third-level cache (L3 cache). The L1 cache can be divided into a data cache (D-cache) for caching data and an instruction cache (I-cache) for caching instructions. The L2 cache and the L3 cache can cache data. In some embodiments, each CPU core can have its own L1 cache and L2 cache, and all CPU cores can share the L3 cache (which is also referred to as a last level cache (LLC)). The LLC can reduce the time required for the processor to access the main memory, thereby improving system performance. Since the LLC is shared with the processor cores, it is possible to effectively coordinate data transmission, reduce cache conflicts and improve multi-core performance.
4. Cache line. Cache line refers to a unit where the computer device performs read or write operations on the storage space of the main memory. The cache line size may be 64 bytes (B).
5. Page. Page refers to a unit used by a computer device to manage memory storage space. For example, the page size is 4 kilobytes (KB), 2 megabytes (MB), or other bytes. A 4 KB page may be referred to as a small page. A 2 MB page may be referred to as a huge page. The smaller the page, the more resources the computer device needs to manage memory. The larger the page, the less resources the computer device needs to manage memory. A page may include a plurality of cache lines. The page size is a multiple of the cache line size.
6. Side-channel attack. Side-channel attack is a technique that exploits security vulnerabilities that can leak confidential information from the system. An attacker performing the side-channel attack can infer encrypted information and unencrypted information (which includes an encryption key) of a victim by exploiting non-functional information that the system inadvertently leaks. For example, the attacker can steal the encrypted information or other security information of the system by measuring or analyzing some physical parameters (such as power supply current, operating time, electromagnetic radiation, etc.) of the system. For example, the attacker may determine an encryption key based on the time for decoding the information.

In the cloud computing environment, based on the virtualization technology, the hardware resource (such as computing resource, storage resource, network resource) in the cloud system can be virtualized, and a plurality of VMs can be deployed in the cloud system. Each VM uses a part of the hardware resource. The computing resource includes CPU, graphics processing unit (GPU), (neural processing unit (NPU), etc. The storage resource includes solid state drive (SSD), hard disk drive (HDD), etc. The network resource includes network interface card (NIC), etc. A plurality of VMs can run on a physical computer. For example, a CPU is virtualized into multiple logically independent virtual CPUs, and the virtual CPUs can independently run different operating systems and application programs. Based on the virtualization technology, a cloud provider can allocate CPU and computing resources to multiple client VMs. Multiple client VMs being deployed on the same physical CPU share the cache. The information that multiple VMs need to protect is stored in different areas (e.g., pages) in the main memory, and the different areas in the main memory are mapped to different areas in the cache.

In the side-channel attack scenario, referring to FIG. 1B, the attacker can disguise as a VM to probe areas in the cache shared by multiple VMs. When a VM as a victim accesses a cache area (for example, the victim VM performs a read-write operation on a corresponding cache area), the attacker will probe the cache area that is shared by the attacker and the victim when the victim performs an operation on the cache area and analyses the leaked information (e.g., read-write time), thus stealing the critical information (e.g., encryption key) that the victim needs to protect and even performing malicious operations.

In order to mitigate the above side-channel attack, in some examples, it may be possible to modify software and/or hardware to prevent information leakage through the shared cache. For example, in the hardware, the cache used by multiple VMs may be isolated, and the multiple VMs do not share the cache, so that cache-based side-channel attacks cannot be mounted. However, existing hardware resources may not be applicable to this manner for mitigating the attack, resulting in increased costs. As another example, in the software, for a cache area that each victim VM accesses, by creating a disturbance thread (e.g., a thread that can meaningless repeatedly access to the cache, meaningless information is created to disturb the attacker probing the cache area, which makes it difficult for the attacker to steal the protected information of the victim. However, this approach for mitigating attacks requires additional resources to create new thread, resulting in wasted resources and increased costs.

Some embodiments of the present disclosure provide a method for data storage, which is applied to a cloud system. The cloud system includes a control device and a plurality of VMs. The control device can map critical information to be protected of each VM in the same area of the cache. Since the plurality of VMs can access the same area of the cache, the side-channel attacker cannot infer meaningful results. For example, referring to FIG. 1C, critical information to be protected of VM1, VM2 and VM3 is mapped to the same cache area. When the attacker VM4 performs the side-channel attack on VM1, critical information to be protected of VM1 will be covered by critical information to be protected of other VMs, which causes change in non-functional information related to the critical information to be protected of VM1, and the attacker VM4 cannot steal the critical information to be protected of VM1 by analyzing the non-functional information. In this way, the attack on the critical information to be protected is avoided, and the protection of each VM is enhanced. In addition, the embodiments of the present disclosure can mitigate the side-channel attack using existing threads of multiple VMs, and do not need to add other new threads and modify hardware resources. Therefore, the cloud system can prevent attacks while spending as less resources as possible.

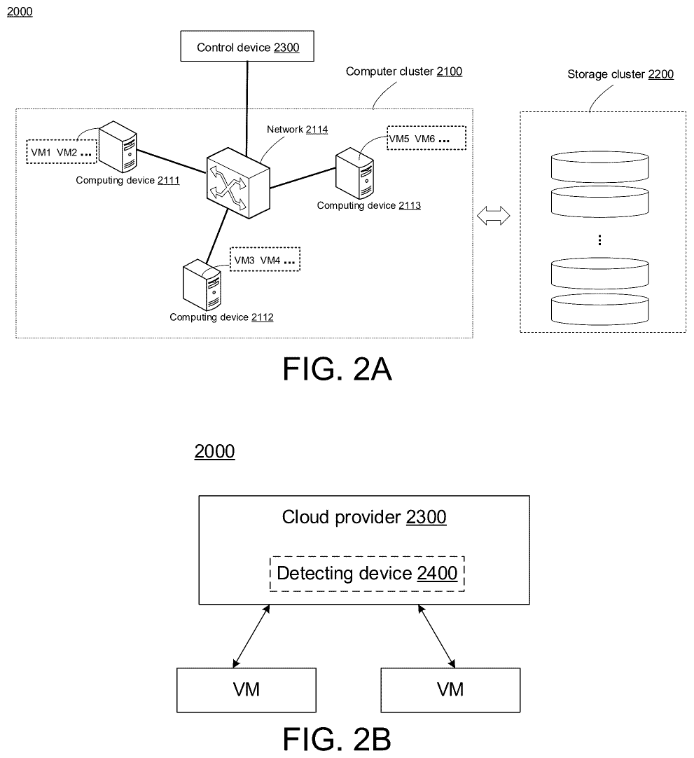

FIG. 2A is a schematic diagram showing an architecture of a computer network system provided in some embodiments of the present disclosure. For example, the computer network system can be regarded as a cloud system (as shown in FIG. 2B), e.g., a distributed computing system.

In some embodiments, as shown in FIG. 2A, the computer network system 2000 includes a computer cluster 2100. The computer cluster 2100 includes a plurality of computing devices. For example, as shown in FIG. 2A, the plurality of computing devices include a computing device 2111, a computing device 2112, and a computing device 2113, and these computing devices are used to provide computing resources. A computing device can include multiple processors or multiple processor cores, and each processor or processor core may be a computing resource; therefore, a physical computing device can provide multiple computing resources. The computing device 2111, computing device 2112, and computing device 2113 are interconnected through a network 2114. The network 2114 may be the Internet, or other networks such as Ethernet. The network 2114 may include one or more network devices, such as a router or a switch.

In some examples, one or more VMs may be deployed in a computing device. For example, VMs such as VM1 and VM2 are deployed in the computing device 2111, VMs such as VM3 and VM4 are deployed in the computing device 2112, and VMs such as VM5 and VM6 are deployed in the computing device 2113. In other examples, the computing resource of a VM can be provided by multiple computing devices. For example, the computing resource of a VM is provided by the computing device 2111, but the storage resource of the VM is provided by the computing device 2113. The VM is a complete computer system that is simulated by software, has hardware system functions, and runs in a computing device. Deploying VMs can enable computing devices to fully utilize their performance and improve CPU utilization.

In some embodiments, referring to FIG. 2A, the computer network system 2000 further includes a storage cluster 2200 for storing data required for devices in the computer network system 2000. The storage cluster may include one or more memory devices, such as disks.

In some embodiments, as shown in FIG. 2A, the computer network system 2000 further includes a control device 2300. For example, as shown in FIG. 2B, the computer network system 2000 is a cloud system, and the control device 2300 may be a cloud provider or a device that executes the hypervisor. The cloud provider is a company that offers components of cloud computing, such as infrastructure as a service (IaaS), software as a service (SaaS), or platform as a service (PaaS). The control device 2300 may be interconnected with the plurality of computing devices through the network 2114 to control computing resources of the plurality of computing devices. The control device 2300 may be used to perform the method for data storage described in the embodiments of the present disclosure.

In some embodiments, as shown in FIG. 2B, the computer network system 2000 may further include a detection device 2400. For example, the detection device 2400 may be arranged in the control device (e.g., a cloud provider) 2300. The detection device 2300 can be used to detect whether there is an attack in the cloud system. For example, the detection device may be a device with detecting functions such as a detector.

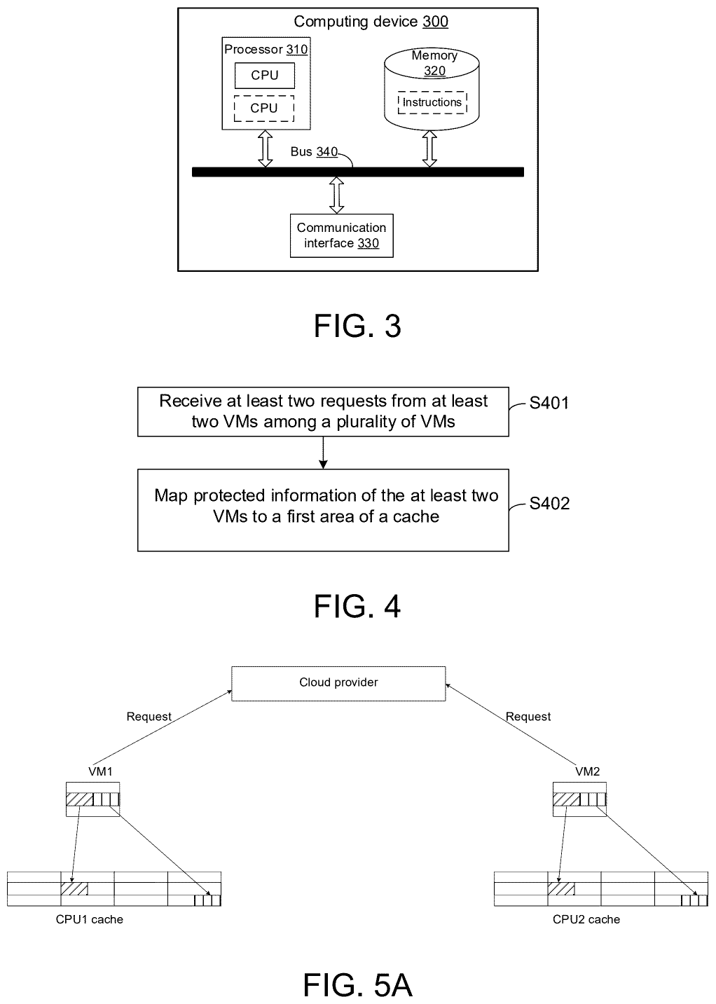

Some embodiments of the present disclosure provide a computing device. The computing device can be used to implement the method for data storage described in the following embodiments. For example, the computing device may be a device with computing functions, such as a host, a computer, etc. FIG. 3 is a schematic diagram showing a structure of a computing device provided in the embodiments of the present disclosure. As shown in FIG. 3, the computing device 300 may include at least one processor 310.

For example, the processor(s) 310 may include one or more of a central processing unit (CPU), a graphics processing unit (GPU), a microprocessor (MP), a digital signal processor (DSP) and other processors. The CPU is a single-CPU or a multi-CPU.

In some embodiments, as shown in FIG. 3, the computing device 300 further includes a memory 320 coupled to the at least one processor 310. For example, the memory 320 may include volatile memory, such as random access memory (RAM). The memory 320 may also include non-volatile memory, such as read-only memory (ROM), flash memory, hard disk drive (HDD) or solid state drive (SSD). The memory 320 may be used to store information (e.g., configuration information) of VMs.

In some embodiments, the computing device further includes a main memory and a cache. The main memory may be used to store information of VMs such as protected information of the VMs. The cache may be used to cache the information of the VMs. The protected information of the VMs may be mapped to the cache. For example, the main memory may be volatile memory or non-volatile memory, or may include both volatile memory and non-volatile memory. The non-volatile memory may be ROM, programmable ROM (PROM), erasable PROM (EPROM), electrically EPROM (EEPROM) or flash memory. The volatile memory may be RAM, which acts as an external cache. By way of illustration, but not limitation, many forms of RAM are available, such as static RAM (SRAM), dynamic RAM (DRAM), synchronous DRAM (SDRAM), double data date SDRAM (DDR SDRAM), enhanced SDRAM (ESDRAM), synchlink DRAM (SLDRAM) and direct rambus RAM (DR RAM).

In some embodiments, as shown in FIG. 3, the computing device 300 further includes a communication interface 330, and the communication interface 330 is used for communication or interaction between the computing device 300 and external device(s). For example, the communication interface 330 may be used to receive requests sent by the VMs. The communication interface 330 may be a wired interface, such as a fiber distributed data interface (FDDI) or a gigabit ethernet (GE) interface. Alternatively, the communication interface 330 may be a wireless interface.

In some embodiments, as shown in FIG. 3, the computing device 300 further includes a bus 340. The bus connects the above-mentioned components, such as the processor(s), the memory, the main memory, and the communication interface. The bus 340 may be a peripheral component interconnect (PCI) bus or an extended industry standard architecture (EISA) bus. The bus may be divided into an address bus, data bus, control bus, etc. For convenient of illustration, only one line is used to represent the bus 340 in FIG. 3, but it does not mean that there is only one bus or one type of bus.

The computing device 300 may perform one or more steps of the method for data storage described in embodiments of the present disclosure. The steps of the method for data storage provided in the embodiments of the present disclosure can be implemented in hardware or software. In some examples, the processor 310 implements the method for data storage in the embodiments of the present disclosure by reading computer instructions stored in the memory 320; or the processor 310 implements the method for data storage in the embodiments of the present disclosure by using instructions stored therein. In the case where the processor 310 implements the method for data storage in the embodiments of the present disclosure by reading the computer instructions stored in the memory 220, the memory 320 stores the computer instructions for implementing the method for data storage provided in the embodiments of the present disclosure. For example, the computer instructions can be stored in the memory 320; and when executed on the at least one processor 310, the computer instructions may cause the at least one processor 310 to perform one or more steps of the method for data storage provided in the embodiments of the present disclosure. Therefore, the beneficial effects achieved by the computing device provided in the embodiments of the present disclosure are the same as the beneficial effects of the method for data storage provided in the embodiments of the present disclosure, and details are not provided here.

FIG. 4 is a flow diagram of a method for data storage provided in some embodiments of the present disclosure. The method for data storage provided in the embodiments of the present disclosure can be applied to a cloud system. The cloud system includes a control device and a plurality of VMs. The control device is configured to perform the method for data storage.

It can be understood that in the embodiments of the present disclosure, the control device can perform some or all of the steps in the embodiments of the present disclosure. These steps or operations are merely examples, and the control device can also perform other operations or variations of various operations. Furthermore, the various steps may be performed in a different order than that presented in the embodiments of the present disclosure, and it is possible that not all operations in the embodiments of the present disclosure are performed. The embodiments of the present disclosure may be implemented independently or in any combination, which is not limited by the embodiments of the present disclosure.

The method for data storage provided in the embodiments of the present disclosure can be applied to the computer network system 2000 with a hardware structure as shown in FIGS. 2A and 2B, or a computer network system with a similar structure and functions. Alternatively, it can also be applied to computer network systems with other structures, which will not be limited in the embodiments of the present disclosure.

The embodiments of the present disclosure are described by taking an example in which the control device 2300 in FIGS. 2A and 2B performs the method for data storage. For example, a cloud provider (or a hypervisor) may be run on the control device 2300. As shown in FIG. 4, the method for data storage provided in the embodiments of the present disclosure includes the following steps S401 and S402.

In S401, the control device receives at least two requests from at least two VMs among the plurality of VMs. A request from each VM of the at least two VMs is used to indicate protected information of the VM.

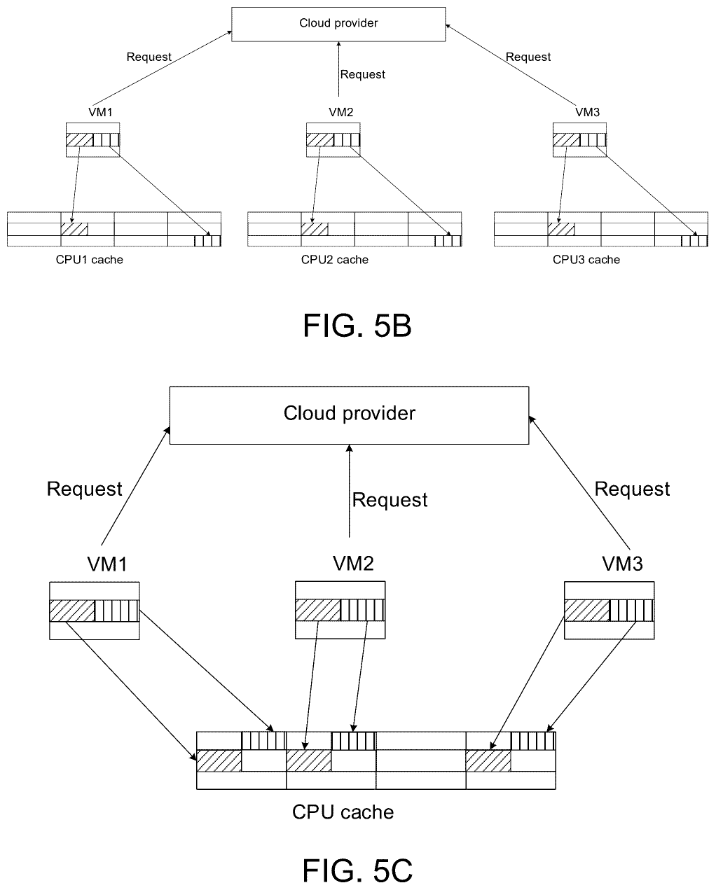

For example, the at least two VMs may include two VMs (e.g., VM1 and VM2 shown in FIGS. 5A, 6A and 7A), or may include more than two VMs (e.g., VM1, VM2 and VM3 shown in FIGS. 5B, 6B and 7B). In some examples, as shown in FIGS. 5A and 5B, different VMs may locate on different CPUs. In some other examples, as shown in FIG. 5C, different VMs may locate on the same CPU but different cache areas.

In some embodiments, the control device receives the at least two requests from the at least two VMs at the same time. For example, the at least two VMs includes a first VM and a second VM, and the control device receives requests from the first VM and the second VM simultaneously.

In some other embodiments, the control device receives the at least two requests from the at least two VMs within a period. For example, within the period, the control device first receives the request from the first VM and then receives the request from the second VM, or the control device first receives the request from the second VM and then receives the request from the first VM. The period may be determined according to practical situations, which will not be limited in the embodiments of the present disclosure.

In some examples, a VM may send a request based on a selection of a client. For example, based on the selection of the client, a VM corresponding to the client sends a request to the control device during the operation of the cloud system. As another example, based on the selection of the client, the VM corresponding to the client sends the request to the control device when the cloud system is under attack.

For example, the request is a function reference, the function reference includes a series of parameters. When the VM sends the request to the control device (e.g., hypervisor), the protected information of the VM may be transmitted to the control device by the series of parameters. After the control device receives the series of parameters, the control device will process the series of parameters, thus performing subsequent operation(s) on the protected information of the VM.

In some examples, the protected information of the VM is referred to information that the VM needs to protect. For example, the information that the VM needs to protect includes information of memory pages (i.e., pages in the main memory) to be protected of the VM, and the information of memory pages to be protected of the VM include information involved in data processing operations or data processing functions of the VM, such as an encryption key and encrypted data involved in an encryption operation. The VM information requested for protection by the VM may be determined by the client or may be default.

In some embodiments, a VM (e.g., each of VM1 to VM6 in FIG. 2A) sends a request to the control device 2300, the request includes storage information of the VM. For example, the storage information of the VM may be allocation information of memory pages of threads of the VM.

In some embodiments, the request of each VM is used to indicate critical information that the VM uses. For example, the critical information is any data vulnerable to a side-channel attack, such data has the property that the contents of the data can have an observable effect on either the data access patterns or instruction flow of a program. In addition, the critical information may include: encryption algorithm, encryption library, packet metadata, interpreted code, persistently stored identity secrets (i.e., public/private keys pairs) used for authentication (e.g., validating identity certificates), message integrity (e.g., digital signatures), and establishing confidential channels (i.e., secret key sharing for the encryption), etc.

In some examples, the request of each VM of the at least two VMs includes an identifier of a computational library that the VM uses. For example, the computational library includes an encryption library.

For example, each VM may use one or more encryption libraries. Different VMs may use the same encryption library. For example, the at least two requests of the at least two VMs include the same identifier of the encryption library. The VMs using the same encryption library have the same memory structure (which means that the layouts of their memory pages are the same); and in these memory pages, locations (e.g., page addresses) for storing the same data structures are the same. For example, the memory page P1 of the VM1 includes data structures D1A, D1B, D1C and D1D; the memory page P2 of the VM2 includes data structures D2A, D2B, D2C and D2D; the data structures D1A and D2A are the same, the data structures D1B and D2B are the same, the data structures D1C and D2C are the same, and the data structures D1D and D2D are the same. In the case where the two memory pages P1 and P2 are in the same layout, the page address of the data structure D1A in the memory page P1 is the same as the page address of the data structure D2A in the memory page P2, the page address of the data structure D1B in the memory page P1 is the same as the page address of the data structure D2B in the memory page P2, the page address of the data structure D1C in the memory page P1 is the same as the page address of the data structure D2C in the memory page P2, and the page address of the data structure D1D in the memory page P1 is the same as the page address of the data structure D2D in the memory page P2. Therefore, the memory pages of different VMs can be easily mapped to the same area of the cache.

For example, victim VM1, VM2, and VM3 use the same encryption library, VM1 uses a first memory page 1, VM2 uses a second memory page, VM3 uses a third memory page, and the first, second and third memory pages have the same layout. In this case, the memory pages of VM1, VM2 and VM3 are mapped to the same cache area, and VM1, VM2 and VM3 may cover each other's cache access pattern, so that the attacker cannot easily identify which access pattern comes from VM1, VM2, or VM3, and it is difficult for the attacker to steal the protected information of the VM1, VM2, or VM3. For example, since the VMs use the same encryption library, when data (e.g., lookup tables) in the encryption or decryption functions needs to be loaded into the main memory, the lookup tables will be loaded into the storage space at the same addresses within the memory pages. After the encryption and decryption functions are loaded into the memory and the data is loaded into the memory, the memory structures of these VMs are basically the same. That is, the memory structures of these VMs have the same layout. In this case, the data that is loaded into the storage space at the same addresses within the memory pages will be mapped to the same area of the cache (e.g., the same cache addresses), so it is difficult for the attacker to distinguish and steal the protected information of VMs.

As another example, the plurality of VMs may use different encryption libraries, and the plurality of VMs may be divided into multiple groups; each group includes VMs using the same encryption library; and the protected information of the VMs using the same encryption library will be mapped to the same area of the cache for protection.

In a case where the encryption library used by the VM has a plurality of encryption algorithms, the request of the VM may indicate the encryption algorithm that the VM uses. For example, the request of the VM includes an identifier of the encryption algorithm that the VM uses. Different encryption algorithms have different operations, so different encryption algorithms need to use different data structures to complete the operations. Therefore, different encryption algorithms in the main memory use different storage space allocations. In the case where different VMs use the same encryption algorithm, the protected information of different VMs that use the same encryption algorithm may have the same storage space allocation in the main memory, which may improve the effect of mapping the protected information of different VMs to the same area of the cache.

In a case where the plurality of VMs may use different encryption algorithms, and the plurality of VMs may be divided into multiple groups; each group includes VMs using the same encryption algorithm; and the protected information of the VMs using the same encryption algorithm will be mapped to the same area of the cache for protection.

For example, the encryption algorithm may include a symmetric algorithm (e.g., including advanced encryption standard (AES) or CAST5), an asymmetric algorithm (e.g., including RSA or digital signature algorithm (DSA)), or a hash algorithm (e.g., MD5 or SHA1). The encryption algorithm and encryption library used by each VM are not be limited in the embodiments of the present disclosure, which can be designed according to practical conditions.

In S402, the control device maps the protected information of the at least two VMs to a first area of the cache.

In this case, since the protected information of the VMs is mapped to the same area of the same cache, the protected information of the VMs overlaps. When the victim VM performs an operation (e.g., read-write operation) on the protected information mapped to the first area of the cache, the processing of the protected information in the first area of the cache by other VMs creates interference (i.e., noise). When the attacker performs the side-channel attack on the victim, the attacker needs to process non-functional information (e.g., read-write time) generated when the victim processes data. Due to the noise of other VMs, it is hard for the attacker to probe and decipher the protected information of the victim and the operation performed by the victim based on the non-functional information of the victim. As a result, it can increase the difficulty for the attacker to carry out the side-channel attack, enhance the protection of information of each VM, and in turn avoid the side-channel attack.

In some embodiments, the control device adjusts storage areas in the main memory for the protected information of the at least two VMs, so that the storage areas for the protected information of the at least two VMs are mapped in the first area of the cache.

In some examples, after the VMs send the requests to the control device (i.e., the cloud provider or hypervisor), the VMs wait for the control device to schedule system resources. The control device can adjust storage areas in the main memory for the protected information of the VMs by reallocating system resource (e.g., memory resource) based on the requests received from the VMs, resulting in the migration of the storage areas in the main memory for the protected information of the VMs. For example, the control device can remap the storage areas (e.g., memory pages) in the main memory for the protected information of the VMs according to the memory page allocation information of the threads of the VMs in the requests sent by the VMs. For example, the protected information of the VM originally stored in a page in the main memory, and after the control device performs the reallocation, the protected information of the VM may be assigned to a new page, and the protected information of the VM may be moved from the original page to the new page. The control device changes a mapping relationship of the VM and the main memory, so that the new page in the main memory can be mapped to the assigned area (the first area) of the cache. However, no matter what kind of memory page the VM is mapped to, the final goal is to map the memory pages of the VMs to the same cache area. That is, the control device maps the memory pages corresponding to the protected information of the VMs to in the same area of the same cache. In this way, the protected information of all the VMs is mapped to the same cache area, so that the protected information of the VMs overlaps.

In the embodiments of the present disclosure, the migration of the storage areas in the main memory for the protected information of the at least two VMs may be performed in different ways, as long as the storage areas for the protected information of the at least two VMs are mapped to the same area of the cache.

In some examples, the control device may migrate the storage area in the main memory for the protected information of a VM of the at least two VMs to a new storage area in the main memory, so that the new storage area in the main memory for the protected information of the VM and storage areas in the main memory for the protected information of other VMs are mapped to the same area of the cache. For example, the plurality of VMs include a first VM and a second VM; protected information of the first VM is stored in a first storage area in the main memory; protected information of the second VM is stored in a second storage area in the main memory, and the first storage area and the second storage area are mapped to different areas in the cache. The control device stores the protected information of the first VM from the first storage area in the main memory into a third storage area in the main memory, and the third storage area and the second storage area are mapped to the first area of the cache.

For example, the protected information of VM1 is stored in the first memory page in the main memory, and the protected information of VM2 is stored in the second memory page in the main memory. The first memory page is mapped to a second area of the cache, and the second memory page is mapped to the first area of the cache. The control device may migrate the protected information of VM1 from the first memory page in the main memory to a third memory page in the main memory, and the third memory page can be mapped to the first area of the cache. In this way, after the migration, the protected information of VM1 and VM2 can be mapped to the first area of the cache.

In some other examples, the control device may migrate the storage area in the main memory for the protected information of each VM of the at least two VMs to a new storage area in the main memory, so that the new storage area in the main memory for the protected information of each VM can be mapped to the same area of the cache. For example, the plurality of VMs include a first VM and a second VM; protected information of the first VM is stored in a first storage area in the main memory; protected information of the second VM is stored in a second storage area in the main memory, and the first storage area and the second storage area are mapped to different areas in the cache. The control device stores the protected information of the first VM from the first storage area in the main memory into a third storage area in the main memory, and stores the protected information of the second VM from the second storage area in the main memory into a fourth storage area in the main memory. The third storage area and the fourth storage area are mapped to the first area of the cache.

For example, the protected information of VM1 is stored in the first memory page in the main memory, and the protected information of VM2 is stored in the second memory page in the main memory. The first memory page is mapped to a second area of the cache, and the second memory page is mapped to a third area of the cache. The control device may migrate the protected information of VM1 from the first memory page in the main memory to a third memory page in the main memory, and migrate the protected information of VM2 from the second memory page in the main memory to a fourth memory page in the main memory; and the third memory page and the fourth memory page can be mapped to the first area of the cache. In this way, after the migration, the protected information of VM1 and VM2 can be mapped to the first area of the cache.

It can be understood that the cache where the protected information of all the VMs is mapped may be a cache in a processor other than a processor where the plurality of VMs are deployed in the cloud system, or a cache in a processor where any of the plurality of VMs is deployed in the cloud system, which is not limited and can be set according to practical conditions.

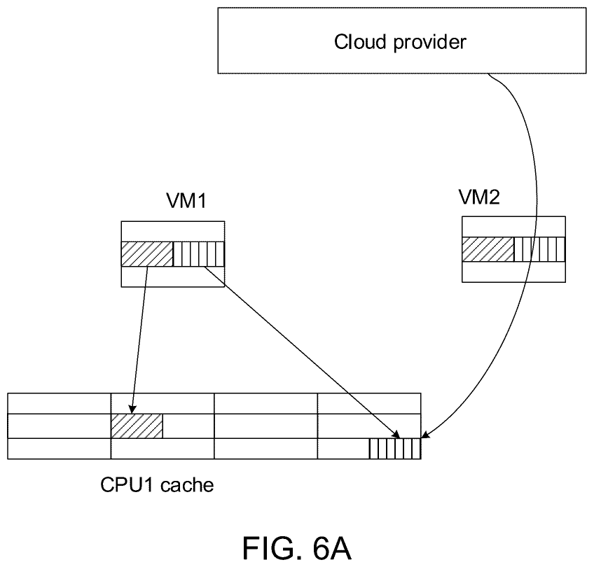

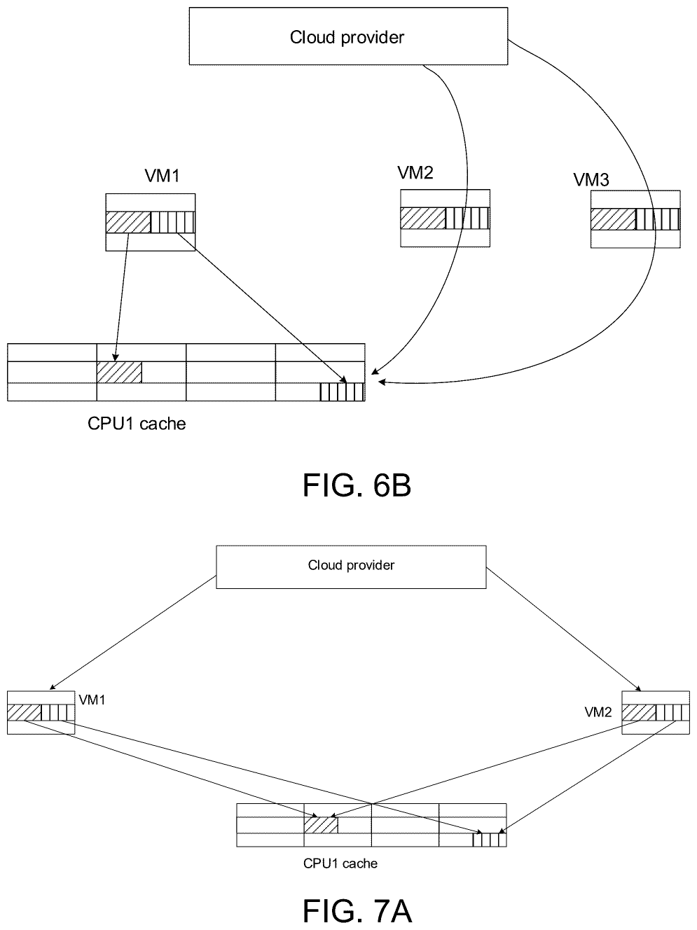

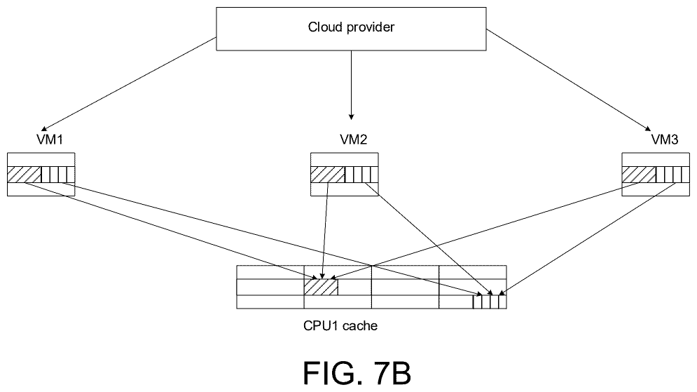

For example, referring to FIGS. 5B, 6B and 7B, the plurality of VMs include a first VM (VM1), a second VM (VM2), and a client VM (VM3). As shown in FIG. 5B, the protected information of the VM1 was originally mapped to the cache (i.e., CPU1 cache) of the processor used by the VM1; the protected information of the VM2 was originally mapped in the cache (i.e., CPU2 cache) of the processor used by the VM2; the protected information of the VM3 was originally mapped to the cache (i.e., CPU3 cache) of the processor used by the VM3; and if the cloud system triggers the defense mechanism against the side channel attack, the client VM1, the client VM2, and the client VM3 will send requests to the control device (i.e., the cloud provider). As shown in FIG. 6B, the control device (i.e., the cloud provider) migrates the protected information of the VMs according to the requests of the VMs. As shown in FIG. 7B, the control device (i.e., the cloud provider) migrates the protected information of the VM2 and the protected information of the VM3, so that the protected information of the VM1, VM2 and VM3 is mapped to the CPU1 cache. In this way, the protected information of each VM is mapped to the same area of the same cache, thus preventing the attacker from extracting the protected information by performing the side-channel attack.

In some examples, the plurality of VMs are deployed on the same computing device. Referring to FIG. 2A, the plurality of VMs may be deployed on any one of the computing devices 2111, 2112 and 2113. For example, the plurality of VMs are deployed on the same CPU and share the last level cache (LLC). In this way, the memory pages for storing the protected information of the plurality of VMs can be mapped to a common cache area.

In some examples, the plurality of VMs are deployed on different computing devices. For example, when the plurality of VMs are deployed on different computing devices, the control device (such as a cloud provider or cloud hypervisor) can migrate the plurality of VMs to the same computing device. For example, the cloud provider migrates the plurality of VMs to the same physical CPU. For example, referring to FIGS. 6A and 6B, the cloud provider may migrate the second VM (VM2) from CPU2 to CPU1; and referring to FIG. 6B, the cloud provider may migrate the third VM (VM3) from CPU3 to CPU1. The cloud provider can migrate VMs sending the same requests including the same identifier of the encryption library to the same physical CPU, so that the plurality of VMs using the same encryption library work on the same CPU and share the same area of the same cache.

In the process where the VM is migrated from one CPU to another CPU, the execution of the VM is suspended. Moreover, since the interruption or pause time of the client VM during the migration process is very short, the execution processes of the client VM will not be affected. In some examples, for the migration of the VM, the resource (data) required for the VM execution may be moved first and then the VM is resumed; and after the VM is resumed, other resource (data) that is not needed for immediate use of the VM may be moved. Therefore, the VM execution may be resumed during the live migration according to practical situations. For example, the VM execution may be resumed after a migration process of the VM is finished; or, the VM execution may be resumed before a migration process of the VM is finished.

The control device may map protected information of different VMs to the same area of the cache in different manners.

In some examples, the control device maps the protected information of the at least two VMs to the same cache line in the first area of the cache. For example, the control device may map the protected information of the first VM to at least one cache line in the first area of the cache, and map the protected information of the second VM to the at least one cache line in the first area of the cache.

For example, different page addresses may be mapped to different cache lines. For example, the CPU can determine which address will be mapped to which cache line through a deterministic method (e.g., a hash function). A memory page storing the protected information of the VM can be allocated to different cache positions, which is referred to as a cache mapping. If a memory page storing the protected information of the VM includes a plurality of memory addresses, then different memory addresses in the memory page will be allocated or mapped to different parts of the cache. For example, a first address in the memory page may be mapped to a position in the cache, and a second address in the same memory page may be mapped to another position in the cache.

In some examples, memory pages corresponding to protected information of different VMs may be mapped to the same cache lines. For example, the protected information of a single VM (VM1) is mapped to different cache lines, and the protected information of other VMs (VM2 and/or VM3) may also be mapped to these different cache lines. In this way, in the cache lines, the protected information of the VM can be covered by the protected information of other VMs, thus preventing the attacker from stealing the protected information of the VM. For example, the page of VM1 has four portions P11, P12, P13 and P14 which have four consecutive page addresses, these four portions P11, P12, P13 and P14 are respectively mapped to four cache lines C1, C2, C3 and C4 which have inconsecutive addresses; the page of other VM (e.g., VM2) may have four portions P21, P22, P23 and P24, these four portions P21, P22, P23 and P24 are respectively mapped to the four cache lines C1, C2, C3 and C4; therefore, in each of the four cache lines C1, C2, C3 and C4, the protected information of the VM1 and VM2 can be covered by each other, so as to mitigate the side-channel attack.

It should be noted that, the VM(s) may generate non-functional information by performing functions they need to perform (e.g., accessing the cache). For example, the read-write time generated when the VM performs read-write operation on the protected information in the cache area is regarded as non-functional information. The attacker steals the protected information by analyzing the non-functional information. However, the protected information of multiple VMs is mapped to the same cache area, and when any VM performs read-write operation on the protected information in the cache area, other VM may also perform read-write operation on the protected information in the cache area. The attacker may take non-functional information generated by other VM as noise, and take non-functional information generated by the victim VM as useful information. Therefore, the useful information that the attacker needs to obtain will be disturbed by noise, and the attacker cannot distinguish the non-functional information of the victim accurately. As a result, the attacker cannot analyze and steal the protected information of the VM.

In addition, the VM may use the encryption library for encryption by calling a function. For example, the VM may encrypt data by calling a function of AES encryption, thereby realizing the encryption process. During the encryption process, the VM may access the main memory, that is, the VM may perform write-read operations on the main memory through memory addresses. The CPU automatically caches some data in the main memory to the cache, so that the VM can read and write data at a fast speed. When the VM accesses a memory address, data in the memory address may be cached in the cache by the CPU, so that the CPU may provide the data in the memory address for the VM faster, which accelerates the speed that the VM accesses the data in the main memory. Therefore, the read-write operations of the VM to the cache are not automatically performed but are determined by the CPU. The VM performs the read-write operations on the data in the main memory, the data in the main memory will be cached into the same area of the cache, which may mitigate the attack on the data, and in turn realize the encryption process. In this way, the access of the VM to the main memory (e.g., the read-write operations of the VM to the data in the main memory) may cause change in the content in the cache, that is, the data in the cache will be continuously updated by the CPU. The change in the content in the cache serves as the non-functional information, which is treated as noise by the attacker.

For example, the VMs perform the same operation at the same time, so that the VMs can mask each other and cover each other's footprints. If there is only one victim VM on the cache, then the attacker will know that there is only one VM on the cache; and whatever actions the victim VM performs, the attacker can easily deduce meaningful results. As a result, the protected information of the victim VM will be leaked. However, when there are two or more VMs on the same cache area and these client virtual machines perform the same operation, any VM can access the cache area; therefore, it is difficult for the attacker to obtain which VM performs the operation. Thus, it can prevent the protected information of the VMs from being extracted by the attacker and protect critical information of the VMs.

It should be noted that, during the side-channel attack, noise generated by the VMs still exists. In order to maintain the noise, it may be possible to monitor noise level to make sure that the VMs generate sufficient noise. In this way, when the noise level decreases, the control device may introduce a new noise source (for example, the control device controls other VM to perform some operations) to keep the noise.

In some embodiments, when the critical information used by the VM includes the identifier of the encryption library and/or encryption algorithm, the control device maps the protected information of VMs that use the same encryption algorithm and/or the same encryption library. In this way, it facilitates the migration of the information requested for protection by the VMs.

The defensive operation against side-channel attacks provided in the embodiments of the present disclosure may be always enabled by the clients' choice, or may be triggered to start when the system is under attack, which is not limited here.

In some embodiments, referring to FIG. 2B, when the detection device 2400 detects that an attack exists in the cloud system 2000, the operation to prevent side-channel attacks will be triggered. For example, when the detection device 2400 detects that there is an attack in the cloud system 2000, the detection device 2400 will send alert information, and the control device 2300 will receive the alert information. After the control device 2300 receives the alert information, the defense is triggered, and the protected information of the VMs can be mapped to the first area of the cache.

If the client and/or control device trusts the detection device 2400 and the detection device 2400 can accurately report the detected attack event, then when the detection device 2400 detects that there is no attack in the cloud system 2000, the control device 2300 receives no alert information, the operation to prevent side-channel attacks will not be triggered. However, regardless of whether the defense is triggered or not, and regardless of whether there is alert information or not, as long as the VM requires the defense, the VM needs to send the request.

On the basis of the above description, in the method for data storage provided in the embodiments of the present disclosure, the control device receives requests sent by the at least two VMs, and maps the protected information of the at least two VMs in the same area (first area) of the cache. In this way, when the attacker attempts to steal the information in the cache, since the protected information of the plurality of VMs overlaps in the cache, when the attacker analyzes the non-functional information of any VM to steal the protected information of the VM, the non-functional information of other VMs will interfere with the analysis of the non-functional information of the VM. Therefore, it is difficult for the attacker to steal the protected information of any VM. In this way, it prevents the protected information of the VMs from being leaked and improves the information security.

In addition, the method for data storage provided in the embodiments of the present disclosure performs defensive operations at the software level, does not create a dedicated partition for the cache, and does not require too many modifications to the client operating system. In addition, without changing the design of the CPU, the existing hardware side channels are closed, and the method can be applied to existing commercial CPUs. The plurality of VMs can have the pages to be protected automatically mapped to the same area of the cache, without increasing new user process, changing the behavior of the user process, affecting the client process and bringing additional system costs.

Moreover, the method for data storage provided in the embodiments of the present disclosure can use non-functional information of other VMs during caching data for defense without generating new threads for active defense, so that the extra cost of the cloud provider is low.

The above embodiments may be implemented in whole or in part through software, hardware, firmware, or any combination thereof. In a case where the above embodiments are implemented by using a software program, the software program may be implemented in whole or in part in a form of a computer program product. The computer program product includes one or more computer instructions. When loaded and executed on a computer, the computer instructions generate some of all of the processes or functions provided in the embodiments of the present disclosure. The computer may be a general-purpose computer, a dedicated computer, a computer network, or any other programmable device. The computer instructions may be stored in a computer-readable storage medium, or transmitted from one computer-readable storage medium to another computer-readable storage medium. For example, The computer instructions may be transmitted from one website site, computer, server or data center to another website site, computer, server or data center through wired (e.g., coaxial cable, optical fiber, digital subscriber line (DSL)) or wireless (e.g., infrared, wireless, microwave) methods. The computer-readable storage medium may be any available medium that may be accessed by the computer, or a server, a data center or any other data storage device including one or more available media. The available medium may be a magnetic medium (e.g., a floppy disk, a magnetic disk or a magnetic tape), an optical medium (e.g., a digital versatile disk (DVD)), a semiconductor medium (e.g., an SSD), or the like.

From description of the above embodiments, those skilled in the art will clearly understand that, for convenience and brevity of description, an example is only given according to the above division of functional modules. In practical applications, the above functions may be allocated to different functional modules to be completed as needed. That is, an internal structure of a device may be divided into different functional modules to perform all or part of the functions described above. For the specific working process of the above-described system, device, and unit, reference may be made to the corresponding process in the foregoing method embodiments, and details will not be repeated here.

In several embodiments provided in the present disclosure, it will be understood that the disclosed systems, devices and methods may be implemented through other manners. For example, the device embodiments described above are merely exemplary. For example, the division of the functional modules or units is only a logical functional division. In actual implementation, there may be other division manners. For example, in some embodiments, a plurality of devices or components may be combined or integrated into another system, or some features may be ignored or not executed. In addition, the mutual coupling or direct coupling or communication connection shown or discussed may be an indirect coupling or communication connection through some interfaces, devices or units, and may be an electrical connection, a mechanical connection or other forms of connections.

The units described as separate components may or may not be physically separated, and the components shown as units may or may not be physical units. That is, they may be located in one place, or may be distributed to multiple network units. Some or all of the units may be selected according to actual needs to achieve the purposes of the solutions in the embodiments.

The functional units in the embodiments of the present disclosure may be integrated into a single processing unit; or, the units may be separate physical units; or, two or more units may be integrated into a single unit. The integrated unit may be implemented in the form of hardware, or may be implemented in the form of software functional unit.

If the integrated unit is implemented in the form of software functional unit and sold or used as an independent product, it may be stored in a readable storage medium. Based on this understanding, the technical solution of the present disclosure, in essence, or all or part of the technical solution, may be embodied in the form of a software product. The computer software product is stored in a storage medium, and includes several instructions to cause a computer device (which may be a personal computer, a server, or a network device, etc.) or a processor to execute all or part of the steps of the methods described in various embodiments of the present disclosure. The storage medium includes various types of medium capable of storing program code, such as a USB such as a flash memory, a portable hard disk, a read-only memory (ROM), a random-access memory (RAM), a magnetic disk, or an optical disk.

Some embodiments of the present disclosure provide a computer-readable storage medium (e.g., a non-transitory computer-readable storage medium). The computer-readable storage medium has stored thereon computer program instructions that, when run on a computer, cause the computer to execute one or more steps of the method for data storage as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an EPROM, a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes computer program instructions carried on a non-transitory computer-readable storage medium. When executed on a computer, the computer program instructions cause the computer to perform one or more steps of the method for data storage as described in the above embodiments.

Beneficial effects of the computer-readable storage medium and the computer program product are the same as the beneficial effects of the method for data storage as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

What is claimed is:

1. A method for data storage, applied to a cloud system that includes a plurality of virtual machines (VMs) and a control device, the method being performed by the control device, the method comprising:
receiving at least two requests from at least two VMs among the plurality of VMs, wherein a request from each VM of the at least two VMs is used to indicate protected information of the VM; and
mapping protected information of the at least two VMs to a first area of a cache.

2. The method of claim 1, wherein mapping the protected information of the at least two VMs to the first area of the cache, includes:
adjusting storage areas in a main memory for the protected information of the at least two VMs.

3. The method of claim 2, wherein the plurality of VMs include a first VM and a second VM; protected information of the first VM is stored in a first storage area in the main memory; protected information of the second VM is stored in a second storage area in the main memory, and the first storage area and the second storage area are mapped to different areas in the cache;
adjusting the storage areas in the main memory for the protected information of the at least two VMs, includes:
storing the protected information of the first VM from the first storage area in the main memory into a third storage area in the main memory, the third storage area and the second storage area being mapped to the first area of the cache.

4. The method of claim 2, wherein the plurality of VMs include a first VM and a second VM; protected information of the first VM is stored in a first storage area in the main memory; protected information of the second VM is stored in a second storage area in the main memory, and the first storage area and the second storage area are mapped to different areas in the cache;
adjusting the storage areas in the main memory for the protected information of the at least two VMs, includes:
storing the protected information of the first VM from the first storage area in the main memory into a third storage area in the main memory; and
storing the protected information of the second VM from a second storage area in the main memory into a fourth storage area in the main memory;
wherein the third storage area and the fourth storage area are mapped to the first area of the cache.

5. The method of claim 1, wherein mapping the protected information of the at least two VMs to the first area of the cache, includes:
mapping the protected information of the at least two VMs to the same cache line in the first area of the cache.

6. The method of claim 1, wherein the request of each VM of the at least two VMs includes an identifier of a computational library that the VM uses.

7. The method of claim 6, wherein the identifier of the computational library included in the request of each VM is the same.

8. The method of claim 1, wherein the request of each VM of the at least two VMs includes storage information of the VM.

9. The method of claim 1, wherein the request of each VM of the at least two VMs is used to indicate critical information that the VM uses, and the critical information includes at least one of an encryption algorithm, an encryption library, packet metadata, an interpreted code, or persistently stored identity secrets.

10. The method of claim 1, wherein the cache is a cache in a processor other than a processor where the plurality of VMs are deployed in the cloud system.

11. The method of claim 1, wherein the cache is a cache in a processor where any of the plurality of VMs is deployed in the cloud system.

12. The method of claim 1, wherein receiving the at least two requests from the at least two VMs among the plurality of VMs, includes:
receiving the at least two requests from the at least two VMs within a period.

13. The method of claim 1, wherein receiving the at least two requests from the at least two VMs among the plurality of VMs, includes:
receiving the at least two requests from the at least two VMs at the same time.

14. The method of claim 1, wherein the cloud system further includes a detection device; and the method further comprises:
controlling the detection device to detect whether an attack exists in the cloud system; and
receiving alert information sent by the detection device when the detection device detects the attack.

15. A computing device, comprising:
a memory; and
at least one processor coupled to the memory;
wherein the memory is configured to store computer instructions that, when executed by the at least one processor, cause the at least one processor to perform:
receiving at least two requests from at least two VMs among a plurality of VMs, wherein a request from each VM of the at least two VMs is used to indicate protected information of the VM; and
mapping protected information of the at least two VMs to a first area of a cache.

16. The computing device of claim 15, wherein mapping the protected information of the at least two VMs to the first area of the cache, includes:
adjusting storage areas in a main memory for the protected information of the at least two VMs.

17. The computing device of claim 16, wherein the plurality of VMs include a first VM and a second VM; protected information of the first VM is stored in a first storage area in the main memory; protected information of the second VM is stored in a second storage area in the main memory, and the first storage area and the second storage area are mapped to different areas in the cache;
adjusting the storage areas in the main memory for the protected information of the at least two VMs, includes:
storing the protected information of the first VM from the first storage area in the main memory into a third storage area in the main memory, the third storage area and the second storage area being mapped to the first area of the cache.

18. The computing device of claim 16, wherein the plurality of VMs include a first VM and a second VM; protected information of the first VM is stored in a first storage area in the main memory; protected information of the second VM is stored in a second storage area in the main memory, and the first storage area and the second storage area are mapped to different areas in the cache;
adjusting the storage areas in the main memory for the protected information of the at least two VMs, includes:
storing the protected information of the first VM from the first storage area in the main memory into a third storage area in the main memory; and
storing the protected information of the second VM from a second storage area in the main memory into a fourth storage area in the main memory;
wherein the third storage area and the fourth storage area are mapped to the first area of the cache.

19. The computing device of claim 15, wherein mapping the protected information of the at least two VMs to the first area of the cache, includes:
mapping the protected information of the at least two VMs to the same cache line in the first area of the cache.

20. A non-transitory computer-readable storage medium, having stored thereon computer instructions that, when executed by a computer, cause the computer to perform:
receiving at least two requests from at least two VMs among a plurality of VMs, wherein a request from each VM of the at least two VMs is used to indicate protected information of the VM; and
mapping protected information of the at least two VMs to a first area of a cache.
